(19) United States
(12) Patent Application Publication
(10) Pub. No.: US 2025/0066252 A1
(43) Pub. Date: Feb. 27, 2025

(54) Fire Resistant Composition

(71) Applicant: Allied Form Tech Corporation, Montgomeryville, PA (US)

(72) Inventors: Corway CHAO, Harleysville, PA (US); Corson CHAO, Harleysville, PA (US); Yen-Yau CHAO, Harleysville, PA (US)

(21) Appl. No.: 18/810,624

(22) Filed: Aug. 21, 2024

Related U.S. Application Data
(60) Provisional application No. 63/533,800, filed on Aug. 21, 2023.

(51) Int. Cl. C04B 28/14; C04B 14/10; C04B 14/18; C04B 14/20; C04B 24/26; C04B 24/42; C04B 28/06; C04B 103/65; C04B 111/00; C04B 111/28; C04B 111/40

(52) U.S. Cl. CPC C04B 28/14; C04B 14/106; C04B 14/185; C04B 14/202; C04B 24/26; C04B 24/42; C04B 28/065; C04B 2103/65; C04B 2111/00525; C04B 2111/00577; C04B 2111/28; C04B 2111/40; C04B 2201/20

(57) ABSTRACT

An insulative and lightweight fire barrier composition contains foam or lightweight aggregate and calcium sulfoaluminate cement or their blend with Portland cement or gypsum hemihydrate. The blocks, coatings, and panels made with such compositions are as non-combustible as fiberglass, mineral, and rock wool insulation, yet possess the dimensional stability and rigidity for manufacturing into blocks and panels with good handling and installation features that these fibrous counterparts are lacking. The fire barrier properties of this composition are comparable with or better than cellular glass, cement, gypsum, and intumescent coatings.

### CROSS-REFERENCE TO RELATED APPLICATIONS

This application claims the benefit of Provisional U.S. Patent Application No. 63/533,800 filed Aug. 21, 2023, the entire disclosure of which is herein incorporated by reference.

### BACKGROUND OF THE INVENTION

Generally, there are 6 major building insulation materials-expanded polystyrene (EPS), extruded polystyrene (XPS), foamed polyurethane (PU), foamed polyisocyanurate (polyiso), fibrous mineral wool, and fiberglass batt. Except the fibrous wool and fiberglass batt, all the other four insulative materials are highly flammable and will produce harmful fumes and smoke upon burning.

For most of the wall, floor, and roof insulations with the requirement of non-flammability and fire ratings, fire resistant and panelized sheets such as gypsum boards are commonly used. Gypsum boards are fire resistant due to the 21% by weight of its crystallized water in gypsum. In contact with fire, the heat will cause thermal decomposition of this crystallized water and the temperature of gypsum will not rise greatly until all of the crystallized water evaporates into water vapor and is released.

In addition to its crystalline water, gypsum boards such as the X or C grade, could become fire rated due to their higher densities (42-45 pcf), glass fibers, and unexpanded vermiculite enforcement. Type X Gypsum boards have thus become the major fire barrier panels in US for residential, commercial, and industrial applications where compliance to the ASTM E-119 fire test requires meeting a 325° F. temperature limit for 1 or 2 hours at the unexposed sides of walls, ceilings, roofs, and floors.

However, after losing its crystalline water and the associated shrinkage and cracking, the fire resistance of gypsum boards reduces drastically and the temperature of the unexposed side could rise quickly in minutes, making them unsuitable for a lot of commercial and industrial applications where longer hours of fire rating or the protection of the steel structures against melting, softening, or collapsing is critical.

A fire barrier composition that meets both the 325° F. E-119 test limit such as gypsum for walls, roofs, and floors and the high temperature protection requirements per E-119 or UL-1709 test for steel structures could be quite desirable.

Structural steel or aluminum beams for high rise buildings are mandated to have fire rated coatings that single sheets of gypsum boards or sprayed gypsum coatings cannot meet. In such cases intumescent materials, lightweight or solid concrete are used.

Intumescent coatings are new fire barrier technologies for steel beams. However, such high solid (60% or greater) and multi-component coatings are usually too expensive for the residential markets. During fire, their delayed expansion into a protective charred layer and smoke from the organics are often concerns of its application. The uneven expansion during charring also makes protection over large areas of steel structure a challenge. The spraying of the high solids slurry in multiple layers often causes overcoating, undercoating, and improper drying/curing which make it even more expensive to work with.

### SUMMARY OF THE INVENTION

It is an objective of this invention to provide a non-flammable and fire rated insulative foam or lightweight aggregate containing cement or gypsum composites as exterior or interior panels, coatings and blocks for the building industry, fire-rated tunnel coatings, and pipe insulations for oil and chemical industries.

It is an objective of this invention to provide a lightweight and water settable inorganic binder that can be cast in factory, pumped into cavities and gaps between claddings and exterior wall, or sprayed onto walls, roofs, and metallic building structures as insulation and fire blocking material.

It is an objective of this invention to provide a lightweight cement or gypsum slurry that can be sprayed, troweled, or coated onto building surfaces such as wood, steel, aluminum, and gypsum boards, encapsulate metal pipes of different configurations, and protect other substrates as a fire barrier coating.

It is an objective of this invention to provide a non-combustible lightweight composite with equal or better fire resistance than the commercially available and fire rated Type X gypsum boards, cellular glass, intumescent coatings, and cementitious coatings.

It is an objective of this invention to provide a fire-resistant lightweight cement composite with fast setting or higher early strength than Portland cement for quick demolding, quick removing from production line, or quick returning of the coated substrate back into service.

It is an objective of this invention to provide an exterior insulation and finishing system without combustible insulation cores, so that the various fire codes could be avoided or complied with.

It is an objective of this invention to provide a non-combustible lightweight coating or laminate that can provide an instant fire barrier to the coated metal, wood, or plastic, whereas commercially available fire barrier intumescent coatings usually need days of drying/curing between multiple coats to build the effective thickness as a fire barrier.

It is an objective of this invention to provide a non-combustible and insulative fill for the ventilation gaps between the exterior cladding and the building walls to prevent the chimney effect of fire associated with ACM claddings and to provide a much better insulation value than the thermal protection from the organic ventilation gaps behind the ACM claddings.

It is an objective of this invention to provide a quick hardening cementitious composite that can be cast at plants or on site. The composite can set in minutes, allow for quick demolding, and serve its function without the long curing time or delay usually associated with conventional Portland cement or intumescent coating.

It is an objective of this invention to provide a fire rated and exteriorly durable panel composite to replace the fire rated gypsum board/mineral wool composites currently used in the market.

It is an objective of this invention to provide a foamed cementitious composite with very low slump to allow thickness build-up in a single pass of a spraying operation, extrusion, and/or quick demolding during the manufacture of panels or blocks of various thicknesses.

It is an objective of this invention to provide a lightweight and insulative material that can easily be cut into panels similar to the foamed polyurethane (PU), polyisocyanurate (polyiso), and extruded polystyrene blocks (XPS) but without the flammability issue associated with these materials.

It is an objective of this invention to provide a non-combustible and insulative material to replace the combustible EPS or XPS currently being used in the exterior insulation finishing systems (EIFS) for outside cladding or as exterior wall insulation for residential and commercial buildings.

### DETAILED DESCRIPTION OF THE INVENTION

In one embodiment, an aqueous foam carrier is generated from a preformed foam such as Elastizell®, Mearlcrete®, or Allied Foam Tech's AFT-425A foaming agent with foam stabilizer AFT-425B as shown in U.S. patent Ser. No. 10/730,795. Allied foam stabilizer AFT-425B can make the preformed foam AFT-425A more stable, allowing for a uniform dispersion of fine fibers in the cementitious slurry.

The preformed foam is used for making a lightweight and hydraulically settable composition, such as a cementitious article involving calcium aluminate cement, calcium sulfoaluminate cement, Portland cement, gypsum hemihydrate, or a combination thereof.

The additives in the cementitious slurry may further comprise lightweight fillers such as clay, metakaolin, fire resistant foam aggregates such as unexpanded or exfoliated vermiculite and expanded perlite, gypsum, accelerators, retarders, water proofing wax or silicone emulsion additives, water reducing plasticizers, superplasticizers, polymers, colorant, thickeners or rheology modifiers, or a combination thereof.

The expanded Vermiculite aggregate used in the present invention is a form of mica, hydrated laminar magnesium aluminum-iron silicate. Interlayer water molecules present are not part of the mineral structure. When subjected to high temperature, the water is vaporized and expands or exfoliates the mineral layers. The result is a low-density inorganic material that has a number of uses as a low-density aggregate for cementitious and agricultural compositions. One function of the aggregate in the invention is to reduce the density of the cementitious mixture to a level compatible with lightweight foam concrete.

Unexpanded vermiculite typically is used to compensate for the shrinkage of gypsum boards upon losing crystalline water. The vermiculites referred to herein can have a volume expansion of about 300% or more of their original volume after being heated for one hour at about 1560° F. (about 850° C.).

The perlite used in the present invention is expanded Volcanic glass. It has uses similar to Vermiculite, including as a low-density aggregate. Acceptable perlite for this composition is very fine-grade, functioning primarily as an additive enhancing fire resistance and weight reduction.

When a stabilized foam, such as one that uses foam agent AFT-425A and foam stabilizer AFT-425B from Allied Foam Tech, is used, the foam agent may be a long-chain organic cation-forming compound, and the foam stabilizer may be a long-chain anion forming compound (U.S. patent Ser. No. 10/730,795). The foam agent and the foaming stabilizer may be present in the stable aqueous foam carrier at a weight ratio of 0.05:1 to 15:1. The stable aqueous foam may be configured to maintain the stability thereof with little to no foam collapse in the event that other additives are added thereto.

The fibers may be hydrophilic fibers, hydrophobic fibers, or a mixture thereof. The fibers may be hydrophilic organic fibers such as polyvinyl chloride fiber. The fibers may be from 0.1 to 20% by weight of the stable aqueous foam; and the fibers may have denier per filament (dpf) values from 0.5 to 250, preferably from 0.5 to 25.

In one embodiment, a hydraulically settable insulative composition comprises: (1) an aqueous foam carrier and (2) a hydraulic mixture comprising cement, fine pozzolanic additives, aggregates, or a mixture thereof.

The hydraulic mixture may comprise cement, gypsum, and fine pozzolanic additives. The cement may be calcium sulfoaluminum cement, calcium aluminate cement, slag cement, or a mixture of the said sulfoaluminum cements blended with Portland cement Types I-V. The hydraulic mixture may include kaolin clay, sand, pozzolanic additives made of metakaolin, silica fume, fly ash, ground furnace slag, or a mixture thereof.

The hydraulically settable composition may be configured to set in days when typical Portland cement is used or in minutes to hours for quick demolding during production by using calcium sulfoaluminate, calcium aluminate with retarders such as citric acids. In fire barrier applications at high temperatures, sulfoaluminate cements are preferred and fire-resistant foam aggregates such as perlite and vermiculite can be used for further improved fire resistance.

The hydraulically settable composition may have a density between 3 pcf and 70 pcf, and lower densities are preferred as heat insulators and effective fire barriers.

In one embodiment, a cementitious article may be formed from the hydraulically settable calcium sulfoaluminate, wherein the cementitious article is one of a coating, encapsulant, block, a wall, floor panel, or floor underlayment.

In one embodiment, a cementitious article may be formed from the hydraulically settable composition, wherein the foamed fiber cementitious core is sandwiched between two fiberglass mats, two fiberglass scrims, or a combination of the two.

In one embodiment, a cementitious article may be formed from the hydraulically settable composition, wherein the cementitious article is a crack-resistant and water-resistant building material with good insulative properties and good fire resistance.

In one embodiment, a process for forming a hydraulically settable composition comprises: (a) preparing an aqueous hydraulic slurry comprising one or more of cement, pozzolanic additives, and aggregates; (b) adding an aqueous foam comprising a foam agent or a foam with foam stabilizer; and (c) adding 0.5-35% fibers such as PVA, PP, basalt, nylon, glass, or others by weight based on the aqueous hydraulic slurry mixed with the aqueous stable foam.

The fibers may be premixed with the foam and then, as a fiber containing stable foam, mixed into the aqueous slurry. The fibers may also be mixed into the slurry at the same time when foam is fed into the slurry during mixing.

The embodiments and the compositions disclosed in the present invention are not necessarily mutually exclusive to each other and may be used together.

The polymer may be an emulsion, dispersion, or powder, and has a concentration of up to 30% by dry weight of the hydraulic substance. For fire barrier applications, less than 5% polymer based on the total amount of hydraulic substance is preferred.

The polymer may be selected from the group consisting of polyurethane, polyacrylic copolymers, ethylene vinyl acetate copolymers, synthetic and natural rubber emulsions, polyisocyanurate dispersions, aqueous urea formaldehyde solutions, and mixtures thereof. The composition may further include alkali citrates, silicates, calcium carbonate, lithium carbonate, or mixtures thereof as accelerators or retarders, as well as a plasticizer or superplasticizer for high early strength at low water to cement ratio in the various mixes.

The foam composition may be cast as an insulative core with an alkali-resistant fiberglass scrim or mat for ease of handling, installation, and performance in exterior and interior applications. The composition may be incorporated into a foamed cementitious composite, such as an organic insulative panel, with the foamed fiber composition of this invention as a fire barrier protecting the flammable insulative cores such as EPS, XPS, polyethylene, polyurethane, or polyisocyanurate. The composition may be incorporated into a foam fill for sandwich panels, wall cavities between claddings and exterior walls, flooring, steel beams, and roof coatings for added insulation and fire protection similar to that of fire barrier intumescent coatings. The aqueous foam may include 50-95% by volume of the composition.

### Examples

### 1. Small Scale Fire Rating Test Simulating ASTM E-119 Setup

### A. Sample Preparation

Rectangular samples at 3 inches by 4 inches at various specified thicknesses were cast in molds and dried by oven or at room temperature before testing.

### B. Test Setup

A steel plate of 3 inches by 4 inches is used in front of the samples and mounted on a fire brick, secured by fire bricks on either side. Two K-type thermocouples are set up at the center of the front and back of the test piece. Fiber glass or mineral wool insulations are used to cover the unexposed thermocouple on the back side.

### C. Testing

Propane torches are used as the firing source with adjustment to allow the temperature reading at the front surface to reach the specified temperature while maintaining the specified front temperature (fire exposed side) at ±25° F. Backside temperature is recorded at specified time intervals (10 to 30 seconds) for the total duration of the firing needed.

The front temperature for fire rating should follow the ASTM-119 guideline as follows:

| | | |
|---|---|---|
| 5 | minutes | 1000° F. (538° C.) |
| 10 | minutes | 1300° F. (704° C.) |
| 30 | minutes | 1550° F. (843° C.) |
| 1 | hour | 1700° F. (927° C.) |
| 2 | hours | 1850° F. (1010° C.) |
| 4 | hours | 2000° F. (1093° C.). |

2. Industrial Scale Production of Foamed Slurry with an Aqueous Foam with Foam Stabilizer

In producing industrial scale foam output with commercial cement mixers and blenders, preformed foam of this kind could be made with a 2-4% aqueous dilution of foam agent AFT-425A, with or without added fillers such as kaolin clay or thickeners, fed into a two pumps foam generator such as Allied Foam Tech's AFT-G6. For example, compressed air is fed into the generator at 60-100 psi through an electronically controlled solenoid valve. The preformed foam is then stabilized inside the foam generator with the foam stabilizer AFT-425B that is fed through a second pump. After further homogenization through a plurality of mixing chambers within the foam generator, a very stable aqueous foam is produced. The preformed foam can then be pumped into a cement mortar mixer with mixing paddles or ribbons. Organic or mineral fibers of various kinds can then be added into the preformed foam under low shear paddle mixing.

Our preferred foamed composite density of this invention is >4 pcf. Table 1 showed that after exposure to a fire of 1,750° F. for 15 minutes, the fire resistance of a 12.4 pcf foamed slurry (Sample 2) has an unexposed side temperature of 150° F. while the 8.4 pcf sample (Sample 1) already reached 320° F.

TABLE 1
Density of Mineral Foam on Fire Resistance at Low Densities (< 30 pcf)

| | Sample 1 | Sample 2 |
|---|---|---|
| Foam Slurry Formulation | 170 Stabilized Foam 1 | 105 Stabilized Foam 1 |
| Preformed Foam Used | (Table 1) | (Table 1) |
| Rhoplex MC-76 polymer emulsion | 20 | 5 |
| Water | 29 | 33 |
| Calcium Sulfoaluminate | 100 | 100 |
| Naphthalenesulfonate H₂O Reducer | 1 | 1 |
| Polyvinyl Alcohol Fiber | 2 | 2 |
| Foam Slurry Density (pcf) | 8.4 | 12.4 |
| Foam Thickness Used (inches) | 1 | 1 |
| Time exposed to Fire (min) | 15 | 15 |
| Temperature of Fire Exposed side (° F.) | 1,750° F. | 1,750° F. |
| Temperature of Unexposed Side (° F.) | 320° F. | 150° F. |

Fire rated X gypsum boards at ⅝″ have a typical fire rating of 30 minutes per E-119. When compared with the foamed CSA (calcium sulfoaluminate) of this invention in a fire test, Table 2 shows that firing at 1,810° F. for 50 minutes, the ⅝ X gypsum control (Comparative Sample in Table 2) already reached a temperature higher than 200° F. at the backside, while the composition of this invention (Sample 1c in Table 5) still maintained a backside temperature of 120° F., even the density was only 12.4 pcf with an R value significantly better than the X gypsum board.

TABLE 2
Fire Resistance and Insulation R Value - Mineral Foam
of This Invention vs Fire Rated Type × Gypsum Board

| | | | 5/8″ Type X | |
|---|---|---|---|---|
| | | | Gypsum Board | |
| | Sample 1 | | (comparative) | |
| Preformed Foam | 105 AFT-425A/425B | | — | |
| | Foam | | | |
| Water | 32 | | — | |
| Rhoplex MC-76 polymer | 5 | | — | |
| emulsion | | | | |
| Calcium Sulfoaluminate | 100 | | — | |
| Perlite | 15 | | — | |
| Naphthalenesulfonate | 1 | | — | |
| Superplasticizer | | | | |
| Foam Density (pcf) | 12.4 | | 43 | |
| Foam Thickness (inches) | 2 | | 2 × 5/8″ pieces | |
| Insulation “R” Value per | 2.70 | | 0.65 | |
| Inch | | | | |
| Time exposed to Fire (min) | 25 | 50 | 25 | 50 |
| Temperature of Fire | --------------- 1810° F. --------------- | | | |
| Exposed side (° F.) | | | | |
| Temperature of Unexposed | 120 | 120 | 150 | >200 |
| Side (° F.) | | | | |

The use of more fire-resistant fibers such as glass fibers and basalt fibers could further boost the fire rating of this invention. Table 3 shows that in a 1/1 CSA/Portland cement slurry, when PVA fibers are replaced with the more fire-resistant basalt fibers, the basalt fiber containing foamed CSA reaches a backside temperature of 260° F. as firing time reaches 40 minutes at 1, 810° F. (Sample 2 in Table 3) while the composition with all PVA fibers (Sample 1) already reached 358° F.

TABLE 3
Impact of Non-organic Fibers on Fire Resistance
of the Mineral Foam of this Invention

| | Sample 1 | | Sample 2 | |
|---|---|---|---|---|
| | 105 Stabilized Foam 1 | | 105 Stabilized Foam 1 | |
| Preformed Foam | (Table 1) | | (Table 1) | |
| Water | 32 | | 32 | |
| Fiber | 2 polyvinyl alcohol | | 1 basalt Fiber & 1 PVA | |
| | (PVA) | | | |
| Calcium Sulfoaluminate | 50 | | 50 | |
| Cem. | | | | |
| Portland Cement I/II | 50 | | 50 | |
| Naphthalenesulfonate | 1 | | 1 | |
| Foam Density (pcf) | 12 | | 12 | |
| Foam Thickness (inches) | 1 | | 1 | |
| Time exposed to Fire (min) | 25 | 40 | 25 | 40 |
| Temperature of Fire Exposed | --------------- 1810° F. --------------- | | | |
| side (° F.) | | | | |
| Temperature of Unexposed | 162 | 260 | 165 | 358 |
| Side (° F.) | | | | |

A composition of this invention replacing part of Portland cement with CSA will significantly boost fire resistance versus the foamed control with all Portland cement. Sample 1 without CSA in Table 4 shows that fired at 1,810° F. for 20 minutes, the backside temperature already reached above 470° F., while the composition of this invention with 50% Portland cement replaced with CSA (Sample 2) still maintained a backside temperature of 170° F.

TABLE 4
Impact of Blended Cement on Fire Resistance
of the Mineral Foam of this Invention

| | Sample 1 | | | |
|---|---|---|---|---|
| | (comparative) | | Sample 2 | |
| Preformed Foam | 98 Stabilized Foam | | 105 Stabilized Foam | |
| Water | 29 | | 33 | |
| Fiber | 2 PVA | | 2 PVA | |
| Cement | 100 Cem Type 1 | | 50 Cem Type 1/ 50 CSA | |
| Other additives | 15 perlite | | 15 perlite | |
| Naphthalenesulfonate | 1 | | 1 | |
| Superplasticizer | | | | |
| Foam Density (pcf) | 12 | | 12 | |
| Foam Thickness (inches) | 1 | | 1 | |
| Time exposed to Fire | 12 | 20 | 12 | 20 |
| (min) | | | | |
| Temperature of Fire | --------------- 1810° F. --------------- | | | |
| Exposed side (° F.) | | | | |
| Unexposed Side (° F.) | 165 | >470 | 170 | 170 |

When the stabilized foam of this invention is used to incorporate water repelling silicone emulsion before adding into the CSA slurry of this invention, the water uptake is greatly reduced. Table 5 shows that in a 24 hours water soak study, the 1.6% use of Dow's silicone emulsion in a low density (12-16 pcf) foamed CSA (Sample 2 in Table 5), the 24 hours water soak by volume % is reduced from >40% (Sample 1) to 12.5% (Sample 2).

TABLE 5
Water Resistance of the Composition of this Invention

| | Sample 1 | Sample 2 |
|---|---|---|
| | 105 | 105 |
| | Stabilized | Stabilized |
| Preformed Foam | Foam | Foam |
| Water | 33 | 33 |
| Silicone Emulsion^{a} | 0 | 1.6 |
| Calcium | 100 | 100 |
| Sulfoaluminate | | |
| Naphthalenesulfonate | 1 | 1 |
| Superplasticizer | | |
| Foam Density (pcf) | 12-16 | 12-16 |
| Foam Thickness | 1 | 1 |
| (inches) | | |
| Time Exposed to Water | 24 | 24 |
| Immersion (hours) | | |
| Volume % Water | >40% | 12.5% |
| Uptake | | |

^{a}Dow silicone emulsion Dowsil 6694.

Adding clay filler such as kaolin clay in the foamed slurry of this invention could increase the viscosity and reduce slump, this will allow the foamed slurry to be sprayed onto vertical surfaces and structural beams with thickness in simple passes. Table 6 shows that adding 16 g clay in a 100 g cement mix allowed a 2-inch thick build-up on a vertical surface without sagging (Sample 2 in Table 6) while the slurry without clay fell to the ground instantly (Sample 1 in Table 6). Moreover, the foamed slurry with clay (Sample 2) shows a better fire resistance with a backside temperature of 240° F. after firing at 1,600° F. for 1 hour. The one without clay (Sample 1) reached a backside temperature of 310° F. in the same test.

TABLE 6
Impact of Clay Filler on Slump and Improved Fire Resistance
of the Mineral Foam Block of this Invention

| | Sample 1 | Sample 2 |
|---|---|---|
| | 105 Stabilized Foam | 105 Stabilized Foam |
| Preformed Foam | (Table 1) | (Table 1) |
| Water | 30 | 30 |
| Clay | 0 | 16 |
| Kaolin clay | 2 PVA | 2 PVA |
| Cement | 50 Cem/50 Calcium | 50 Cem/50 Calcium |
| | Sulfoaluminate | Sulfoaluminate |
| Naphthalenesulfonate | 1 | 1 |
| Foam Density (pcf) | 12 | 12 |
| Foam Thickness (inches) | 2 | 2 |
| Slump at 2″ thick(vertical) | Yes | None |
| Back temp. (1,600° F./1 hour) | 310° F. | 240° F. |

The ASTM E-119 test allows us to evaluate the duration for which certain building elements such as walls, partitions, ceilings, and floors can contain a fire, retain their structural integrity, or exhibit both properties during a predetermined test exposure. Multiple thermocouples are usually installed at both the fire exposed sides and unexposed backsides.

Failure of the test (lost endurance of the assembly) is typically judged by the temperature rise of 250° F. above the ambient temperature on the average of all unexposed surface thermocouple locations. For a room temperature of 75° F., that will be 325° F. We will thus use 325° F. as the Pass/Fail temperature limit in the current work for such nonmetallic building elements.

In producing the composition of this invention, expanded or exfoliated vermiculite or perlite can replace foam to achieve low density and good fire resistance. Table 7 shows that using exfoliated vermiculite in a cement slurry could reduce density to 48 pcf in Sample 1 and 44 pcf in Sample 2. However, upon exposure to firing per E-119 at 20, 65, and 75 minutes, Sample 1 using the CSA cement always shows a lower backside temperature than that of Sample 2 using Portland cement. A fire rated X gypsum board (Sample 3 in Table 7) also can not match the fire barrier. After 75 minutes of fire exposure, the comparative fire rated X gypsum boards, even at 1.25 inches thick (two pieces of ⅝″ combined), exceeded the 325° F. limit per E-119, while Sample 1 was at 220° F.

TABLE 7
Firing Test Per E-119
CSA/Vermiculite Composites vs Portland Cement/
Vermiculite Composite and Commercial Products

| | Sample 1 | Sample 2 | Fire Rated X |
|---|---|---|---|
| | CSA/ | Cement/vermiculite | Gypsum Board |
| | vermiculite | (comparative) | (comparative) |
| Hydraulic Material Used | CSA | Portland Cem I | 5/8″ board |
| Naphthalenesulfonate | 1 | 1 | — |
| Basalt Fiber | 1 | 1 | — |
| Calcium Sulfoaluminate | 100 | — | — |
| Portland Cem I | — | 100 | — |
| Exfoliated vermiculite | 27 | 27 | — |
| Water | 80 | 80 | — |
| Thickness (inches) | 1 | 1 | 1.25 |
| Dry Density (pcf) | 48 | 44 | 44 |
| 20 minutes per E-119(° F.) | 173 | 175 | 148 |
| 65 minutes per E-119(° F.) | 187 | >325 | 233 |
| 75 minutes per E-119(° F.) | 220 | — | >325 |

In a hydrocarbon fire, the quick rise of exposed temperature could reach 2,000° F. in a few minutes, and that may not be adequately predicted by the ASTM E-119 test where the exposed temperature only reaches 2,000° F. at the 3rd hour of furnace exposure. An Underwriters Laboratories UL-1709 has thus been developed to address the performance of fireproofing materials under hydrocarbon fire.

Table 8 shows that a lightweight CSA composite of this invention containing perlite aggregate (Sample 1) consistently shows a much lower backside temperature rise versus that of the comparative Sample 2 using Portland cement with the same amount of expanded perlite.

TABLE 8
Firing Test Per UL-1709
CSA/Expanded perlite Composite vs Portland
Cement/Expanded perlite Composites

| | | Sample 2 |
|---|---|---|
| | Sample 1 | Cement/perlite |
| | CSA/perlite | (comparative) |
| Naphthalenesulfonate | 1 | 1 |
| Calcium sulfoaluminate | 100 | — |
| Portland Cem I | — | 100 |
| Expanded perlite | 43 | 43 |
| Water | 76 | 76 |
| Thickness(inches) | 0.5 | 0.5 |
| Dry Density (pcf) | 46 | 47 |
| Unexposed side temp.(° F.) | 112 (exposed | 195 (exposed |
| (after 4 minutes per UL- | side 1,870° F.) | side 1,870° F.) |
| 1709) | | |
| Unexposed side temp.(° F.) | 377 (exposed | 558 (exposed |
| (after 13 minutes per UL- | side 1,965° F.) | side 1,965° F.) |
| 1709) | | |

Spiking of calcium sulfoaluminate in a foamed gypsum hemihydrate showed an appreciable increase in fire resistance as we have seen in foamed Portland cement slurry with CSA added. Table 9 shows that adding 5% CSA in a foamed gypsum hemihydrate increased its fire resistance significantly per E-119 fire test. After firing for 120 minutes, the backside temperature of Sample 1 (Table 9) containing 5% CSA had a backside temperature of 310° F., while the comparative Sample 2 without CSA showed a backside temperature of 372° F.

TABLE 9
Firing Test Per E-119
CSA in Improving Fire Resistance of Foamed Gypsum Slurry

| | | Sample 2 |
|---|---|---|
| | Sample 1 | Gypsum |
| | CSA/Gypsum | (comparative) |
| Gy[psum hemihydate | 95 | 100 |
| Calcium sulfoaluminate | 5 | 0 |
| AFT-425A/AFT425B foam | 10 | 10 |
| Water | 50 | 50 |
| Thickness(inches) | 1 | 1 |
| Dry Density (pcf) | 36 | 36 |
| Unexposed side temp.(° F.) | 310 | 372 |
| after firing for 120 minutes | | |

Unexpanded vermiculite is used in fire rated X and C gypsum boards to boost the fire resistance by offsetting the fire caused shrinkage of gypsum after losing the crystalline water. Table 10 shows that the use of unexpanded vermiculite together with the 5% CSA containing gypsum composition of this invention (Sample 1 in Table 10), even at 36 pcf, outperformed the commercial fire rated C board at 48 pcf (Sample 2). The backside temperature of Sample 1, after firing for 2.5 hours, still maintained a very low temperature increase (238° F.) while the commercial C board, after firing under the same condition, already reached a backside temperature of 328° F.

TABLE 10
Firing Test (1,750° F. at 1st Hour & 1,850°
F. at 2^{nd} and 3^{rd} Hour) CSA in Improving Fire Resistance
of Fire Rated Gypsum Formulation

| | | Sample 2 |
|---|---|---|
| | | Fire Rated C |
| | Sample 1 | Gypsum Board |
| | CSA/Gypsum | (Commercial Control) |
| Gypsum hemihydate | 95 | — |
| Calcium sulfoaluminate | 5 | — |
| AFT-425A/AFT425B foam | 10 | — |
| Water | 50 | — |
| Unexpanded Vermiculite | 3 | Yes |
| Thickness(inches) | 1.2 | 1.3 (2 × 0.65″) |
| Dry Density (pcf) | 36 | 48 |
| Unexposed side temp.(° F.) | 238 | |
| (After firing for 150 minutes) | | 328 |

3. Small Scale Setup for Measuring Adhesion of Square Blocks of this Invention to Vinyl Surface In the setup a 4″×4“×1” block of foamed cement slurry is cast onto a piece of a clean 1/16″ vinyl sheet. After room temperature cure for one week, the assembly is turned upside down with 2 holding screws drilled into the side of the sample block. A metal wire is tied to the two screws and formed a loop. Metal eight is hung at the bottom of the loop. During the test, weight is gradually increased until the sample block pulled off from the vinyl surface. The maximum weight in lbs. before failure is recorded. The number is further divided by 16 square inches (the horizontal dimensions of the block) to give the maximum adhesion in pounds per square foot (lbs/sq.ft.) Table 11 clearly shows that adding an acrylic polymer latex into the foamed cement slurry of this invention (Sample 1) increased adhesion of the block to the vinyl surface from zero to >100 lbs/ft2. Other emulsion polymers or dispersible polymer powders such as ethylene vinyl acetate copolymers can also be used.

TABLE 11
Impact of Polymers on Adhesion of
this Invention to Vinyl Surfaces

| | Sample 1 | Sample 2 |
|---|---|---|
| | 20 Stabilized | (comparative) |
| | Foam 1 | 20 Stabilized |
| Preformed Foam | (Table 1) | Foam 1 (Table 1) |
| Water | 100 | 70 |
| Rhoplex MC-76 (DOW) | 0 | 35 |
| Pva fiber | 3 | 3 |
| CTS cement | 200 | 200 |
| Naphthalenesulfonate | 1 | 1 |
| Foam Density (pcf) | 35 | 35 |
| Foam block square | 1 inch thick | 1 inch thick |
| 4″ × 4″ (inches) | | |
| Adhesion in lbs./ft² | 0 | >100 |

1. An insulative and fire-resistant composition, the composition comprising:
foamed or lightweight composites containing calcium sulfoaluminate or a calcium sulfoaluminate blend with cement or gypsum,
wherein the composition is capable of being precast or cast-in-place and capable of being used as fire protective coatings, panels, or blocks over wood, metal, plastic and plaster substrates and used as fire resistant exterior cladding of residential, commercial, and industrial buildings.

2. The composition of claim 1, wherein the composition has a density from 2 pcf to 95 pcf.

3. The composition of claim 1, wherein the composition has a density from 2 pcf to 60 pcf.

4. The composition of claim 1, wherein the composition has the calcium sulfoaluminate blend with the cement and the calcium sulfoaluminate is from 2% to 90% in the total weight of the composition.

5. The composition of claim 1, wherein the composition has the calcium sulfoaluminate blend with the cement and the calcium sulfoaluminate is from 2% to 70% in the total weight of the composition.

6. The composition of claim 1, further comprising fibers, clay, furnace slag fillers. plasticizers, superplasticizers, accelerators, retarders, dispersible polymer powers, polymer emulsions, or dispersions.

7. The composition of claim 6, wherein the gypsum blends water proofing additives, gypsum accelerators, retarders, or unexpanded, wherein the water proofing additives are wax or silicone emulsions.

8. The composition of claim 1, wherein the composition has a cellular structure made from either an aqueous foam or fire resistant and porous aggregates, wherein the porous aggregates are expanded perlite or exfoliated vermiculite.

9. The composition of claim 1, wherein the composition has facings of fiber mat, scrims, or reinforcing sheathings for enhanced adhesion and strength.

10. The composition of claim 1, wherein, in the cast-in-place applications, the composition can be pumped, coated, or sprayed onto metal beams and structure supports as fire rated coatings replacing intumescent and cementitious coatings for fire code compliance.

11. The composition of claim 1, wherein the composition at a density lower than 50 pcf is thermally insulative and non-combustible and capable of replacing the combustible expanded polystyrene, polyisocyanurate foams in exterior insulation and finishing systems.

12. The composition of claim 1, wherein the composition is capable of being cut into blocks, panels, or XPS foam or used as part of sandwiched laminates for fire rated exterior and interior floor, wall, and roof applications as insulations, fire blocks, and fire barriers.

13. The composition of claim 1, wherein the composition further comprises fibers and fillers to make the composition be amenable for extrusion or instant demolding, wherein the fillers are clay, fly ash, and lightweight perlite, or vermiculite fillers.

14. The composition of claim 1, wherein the composition further comprises polymer powders, emulsions or dispersions for enhanced adhesion to vinyl surfaces to make fire rated backings for vinyl sidings, replace cellular vinyl cores in vinyl decks, panels.

15. The composition of claim 1, wherein the composition comprises the blends of calcium sulfoaluminate and Portland cement or gypsum hemihydrate and has a weight ratio of calcium sulfoaluminate to Portland cement or gypsum from 20:1 to 1:50.

16. The composition of claim 1, wherein the composition comprises the lightweight composites, excluding foam, and has a weight percentage of the lightweight composites based on the weight of cement or gypsum from 3% to 80%.

17. The composition of claim 1, wherein the composition is cast in place or precast, and the fast-setting nature of the calcium sulfoaluminate in the composition allows a fast production for precast and fast turnaround time for repeated coatings in cast in place operation.

18. The composition of claim 1, in cast-in-place applications, the lightweight composites are sprayed with pressured air or airless using screw pump, diaphragm pump, piston pump, or troweled or brushed onto the substrate.

19. A method of using the composition of claim 1, the composition is precast or cast-in-place, wherein, in the cast-in-place application, the lightweight composites are sprayed with pressured air or airless using screw pump, diaphragm pump, piston pump, or troweled or brushed onto the substrate.
